(19) United States
(12) Patent Application Publication
(10) Pub. No.: US 2024/0086878 A1
(43) Pub. Date: Mar. 14, 2024

(54) MANAGEMENT SYSTEM FOR FUNGIBLE TOKENS AND NON-FUNGIBLE TOKENS AND ASSOCIATED DIGITAL ASSETS

(71) Applicant: Heera Digital Inc., Palo Alto, CA (US)

(72) Inventors: Muhammad Ali Khan, Palo Alto, CA (US); Ram Shanmugam, Palo Alto, CA (US)

(21) Appl. No.: 17/942,104

(22) Filed: Sep. 9, 2022

(51) Int. Cl. G06Q 20/12; G06Q 20/02; G06Q 20/36; G06Q 20/38; G06Q 20/40

(52) U.S. Cl. CPC G06Q 20/1235; G06Q 20/027; G06Q 20/3678; G06Q 20/3829; G06Q 20/40145; G06Q 2220/00

(57) ABSTRACT

A token management server and associated methods are disclosed. In one embodiment, the token management server comprises a gateway engine for indexing digital items stored on web servers and blockchains and comparing the indexed items to a non-fungible token (NFT) and its associated digital asset. The token management server optionally comprises a rights assignment and management engine for automatically generating ownership documentation for an asset associated with the NFT and tracking subsequent changes of ownership of the asset, a successor management engine for automatically assigning ownership and control of the NFT and digital asset or a fungible token if the owner does not interact with the token management server within a certain predetermined amount of time, and a loss prevention engine for providing an owner with a backup mechanism for accessing an NFT and digital asset or a fungible token if the owner loses his or her primary credentials.

### FIELD OF THE INVENTION

A system and associated methods for managing fungible tokens and non-fungible tokens (NFTs) and associated digital assets are disclosed.

### BACKGROUND OF THE INVENTION

Blockchain technology is known in the prior art. At a high level, a blockchain is an open, distributed ledger that can record transactions between two parties in a verifiable and permanent way. A blockchain comprises one or more blocks. Each block comprises a cryptographic hash of the previous block in the blockchain, a timestamp, and a ledger containing transaction data.

FIG. 1 depicts blockchain 100ᵢ, where “i” is the iteration number of blockchain 100, where each iteration contains one additional block compared to the previous iteration. Herein, referring to “blockchain 100” refers to that particular blockchain without specifying a particular iteration. If a specific iteration is being referred to, the “i” subscript will be added.

Blockchain 100ᵢ comprises blocks 101₁, 101₂, . . . , block 101₁. For simplicity, only block 101ᵢ is shown in FIG. 1. Block 101ᵢ comprises header 102ᵢ and ledger 103ᵢ.

Header 102ᵢ comprises hash 104ᵢ of the previous block or the header of the previous block, which here is block 101ᵢ₋₁. Hash 104ᵢ can be created using known hash function techniques, which create a cryptographic hash of fixed length based on the input, which here are the contents of block 101ᵢ₋₁ or the header of block 101ᵢ₋₁. Hash 104ᵢ is a mechanism for authenticating block 101ᵢ, as only a trusted computing device that contains the contents of block 101ᵢ₋₁ or the header of block 101ᵢ₋₁ and the algorithm for the cryptographic hash function will have been able to create hash 104ᵢ of block 101ᵢ₋₁ or its header. An example of a cryptographic hash function is the SHA 256 function, which generates a 256-bit (32 byte) hash output for any given input.

Header 102ᵢ also comprises timestamp 105ᵢ, which is the date and time at which block 101ᵢ was created. Header 102ᵢ optionally comprises difficulty 106ᵢ (which can be a “proof-of-work” algorithm difficulty target for the block), nonce 107ᵢ (which is a counter used for the proof-of-work algorithm), and Merkle root 108ᵢ (which is a summary or hash of the transactions contained in ledger 103ᵢ). Header 102ᵢ can include other information as desired.

Ledger 103i comprises data for one or more transactions that are recorded in block 101ᵢ. In this example, ledger 103 comprises transactions 109_{iA} and 109_{iB}. Various data structures can be used for transactions 109. Typically, transactions 109 will comprises data indicating the parties involved in the transaction, the subject matter of the transaction, the terms of the transaction, and other relevant information.

FIGS. 2 and 3 contain further examples of a prior art blockchain. FIG. 2 depicts blockchain 100₁, which here represents the very first iteration of the blockchain 100₁. Blockchain 100ᵢ comprises only one block, block 101₁. Block 101₁ sometimes is referred to as “the genesis block,” as it is the first block that starts a blockchain.

Block 101₁ comprises header 102₁ and ledger 103₁. Header 102₁ comprises hash 104₁ of block 101₀. Here, block 101₀ does not actually exist (as block 101₁ is the first block of the blockchain), so hash 104₁ will be blank or null in this instance. Ledger 103₁ comprises three transactions, transactions 109_{1A}, 109_{1B}, and 109_{1C}.

FIG. 3 depicts blockchain 100₂, which is the next iteration of blockchain 100₁ after another block, block 101₂, has been added. Block 101₂ comprises header 102₂ and ledger 103₂. Header 102₂ comprises hash 104₂ of block 101₁ or of header 102₁. Ledger 103₂ comprises two transactions, transaction 109_{2A} and 109_{2B}.

FIGS. 1-3 depict a mere example of a blockchain implementation. Other known implementations exist and can be used instead in the embodiments discussed below.

Blocks and blockchains are generated, stored, and retrieved by computing devices. A computing device that generates and/or stores blockchains is referred to as a “node.”

FIG. 4 depicts hardware components of exemplary computing device 400 that can operate as a node. These hardware components are known in the prior art. Computing device 400 is a computing device that comprises processing unit 401, memory 402, non-volatile storage 403, positioning unit 404, network interface 405, image capture unit 406, graphics processing unit 407, and display 408. Computing device 400 can be a server, notebook computer, desktop computer, game system, smartphone, or other computing device, and blockchain processing engine 502 can be a software application running on computing device 400.

Processing unit 401 optionally comprises a microprocessor with one or more processing cores. Memory 402 optionally comprises DRAM or SRAM volatile memory. Non-volatile storage 403 optionally comprises a hard disk drive or flash memory array. Positioning unit 404 optionally comprises a GPS unit or GNSS unit that communicates with GPS or GNSS satellites to determine latitude and longitude coordinates for computing device 400, usually output as latitude data and longitude data. Network interface 405 optionally comprises a wired interface (e.g., Ethernet interface) or wireless interface (e.g., 3G, 4G, GSM, 802.11, protocol known by the trademark “BLUETOOTH,” etc.). Image capture unit 406 optionally comprises one or more standard cameras (as is currently found on most smartphones and notebook computers). Graphics processing unit 407 optionally comprises a controller or processor for generating graphics for display. Display 408 displays the graphics generated by graphics processing unit 407, and optionally comprises a monitor, touchscreen, or other type of display.

FIG. 5 depicts software components of computing device 400. Computing device 400 comprises operating system 501 (such as the operating systems known by the trademarks “WINDOWS,” “LINUX,” “ANDROID,” “IOS,” or others), blockchain processing engine 502, and blockchain wallet 503. Blockchain processing engine 502 and blockchain wallet each comprise lines of software code executed by processing unit 401 to perform certain functions. The prior art includes examples of blockchain processing engine 502 and blockchain wallet 503, but as discussed in greater detail below, the embodiments of the present invention include improvements to prior art blockchain processing engines and to prior art blockchain wallets to provide additional functionality not available in the prior art.

FIGS. 6A to 6E depict an exemplary prior art system and method for generating blockchains.

With reference to FIG. 6A, computing device 400a (which is an instance of computing device 400) stores blockchain 100₁. Computing device 400a might be the device that generated blockchain 100₁, or it might merely be a device that is storing blockchain 100₁, which was generated by a different computing device 400.

With reference to FIG. 6B, computing device 400b wishes to add block 101₂ to blockchain 100₁ to create blockchain 100₂. It first does so locally, using its blockchain processing engine 502 to generate blockchain 100₂, and it then seeks to have all other computing devices 400 that have stored blockchain 100₁ (i.e., other nodes, such as computing device 400a) to add block 101₂ to blockchain 100₁ to generate blockchain 100₂.

With reference to FIG. 6C, computing device 400a receives the request from computing device 400b. Blockchain processing engine 502 in computing device 400a compares a hash of block 101₁ stored in blockchain 100₁ or its header to the hash stored in header 104₂ of block 101₂. If there is a match, computing device 400a knows that the request is legitimate, and it then updates blockchain 100₁ to add block 101₂ to the chain, thus resulting in blockchain 100₂, shown in FIG. 6D. Computing devices 400a and 400b can store blockchains 100₁ and 100₂ in their respective non-volatile storage devices 403.

With reference to FIG. 6E, computing device 400c might then request to add block 101₃ to the blockchain, and a request is sent to computing devices 400a and 400b (and any other nodes) in the same manner described with reference to FIGS. 6B and 6C. If block 101₃ is authenticated by computing devices 400a and 400b, then block 101₃ will be added to blockchain 100₂ to generate blockchain 100₃.

Hereafter, examples of blockchains will be numbered blockchain 200, blockchain 300, etc. It is to be understood that each such blockchain follows the structure and processes described above for blockchain 100, including the use of iterations “i”.

The prior art also includes non-fungible tokens. A non-fungible token (NFT) is a unit of data stored in a blockchain that certifies a digital asset to be unique and not interchangeable with other digital assets. NFTs can be used to represent a variety of unique digital assets, items such as images (e.g., JPEGs, GIFs), videos (e.g., MP4s, WMVs, AVIs), audio (e.g., MP3s, MP4s, M4As), video game items (e.g., JPEGs, GIFs), digital collectibles (e.g., JPEGs, GIFs, MP3s, MP4s, M4As, WMVs, AVIs), and other types of digital files. An NFT provides proof of ownership of the digital asset.

By contrast, other types of digital assets are fungible and therefore cannot be associated with an NFT. Examples of fungible digital assets include fungible tokens such as cryptocurrency (e.g., Bitcoins), traditional currency (e.g., US dollars in a bank account), and a traditional Hollywood movie (e.g., the movie “Casablanca”).

With reference to FIG. 7, exemplary NFT 701 and exemplary fungible token 703 are stored in blockchain 200. NFT 701 certifies digital asset 702. If a user wants to confirm the ownership of, for example, digital asset 702, he or she need only analyze the contents of NFT 701. NFT 701 and digital asset 702, and fungible token 703, are mere examples, and it is to be understood that blockchain 200 can store any number of NFTs and associated digital assets and fungible tokens.

Although blockchain and NFT usage has become prevalent in the prior art, it still is very difficult for an average user to create, obtain, authenticate, and transfer an NFT for a variety of reasons, including substantial cost barriers, a lack of user-friendly interfaces for non-computer programmers to navigate, and other technical limitations.

In addition, the mechanisms for accessing an NFT and its associated digital asset also can be very cumbersome and require the possession of specific digital credentials, such as a digital wallet or key that is associated with the NFT and its associated digital asset at the time of creation or transfer to the owner. If an owner of an NFT and associated digital asset loses the digital credentials or passes away, the NFT and its digital asset essentially are lost because it is difficult if not impossible to find them and to obtain possession of them without the digital credentials. The same is also true of fungible tokens.

What is needed is an improved system for managing NFTs and their associated digital assets and for managing fungible tokens.

### BRIEF SUMMARY OF THE INVENTION

A token management server and associated methods are disclosed. In one embodiment, the token management server comprises a gateway engine for indexing digital items stored on web servers and blockchains and comparing the indexed items to a non-fungible token (NFT) and its associated digital asset. The token management server optionally comprises a rights assignment and management engine for automatically generating ownership documentation for an asset associated with the NFT and tracking subsequent changes of ownership of the asset, a successor management engine for automatically assigning ownership and control of the NFT and digital asset or a fungible token if the owner does not interact with the token management server within a certain predetermined amount of time, and a loss prevention engine for providing an owner with a backup mechanism for accessing an NFT and digital asset or a fungible token if the owner loses his or her primary credentials.

### BRIEF DESCRIPTION OF THE DRAWINGS

FIG. 1 depicts a prior art blockchain.

FIG. 2 depicts an example of an iteration of the prior art blockchain.

FIG. 3 depicts an example of another iteration of the prior art blockchain.

FIG. 4 depicts hardware components of a prior art computing device.

FIG. 5 depicts software components of a computing device.

FIGS. 6A, 6B, 6C, 6D, and 6E depict a sequence of adding blocks to an existing blockchain.

FIG. 7 depicts exemplary NFTs and their associated digital assets.

FIG. 8 depicts a token management server.

FIG. 9 depicts software components of the token management server of FIG. 8.

FIG. 10 depicts a gateway engine operated by the token management server.

FIG. 11 depicts a successor management method performed by the token management server.

FIG. 12 depicts a loss prevention method performed by the token management server.

FIG. 13 depicts an API engine operated by the token management server.

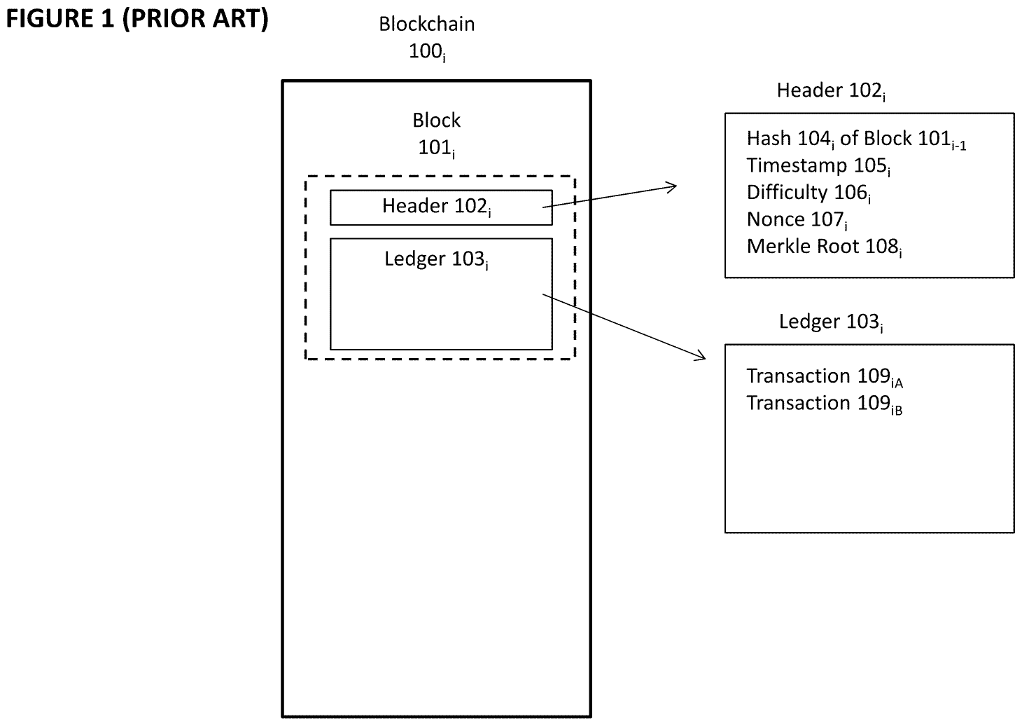

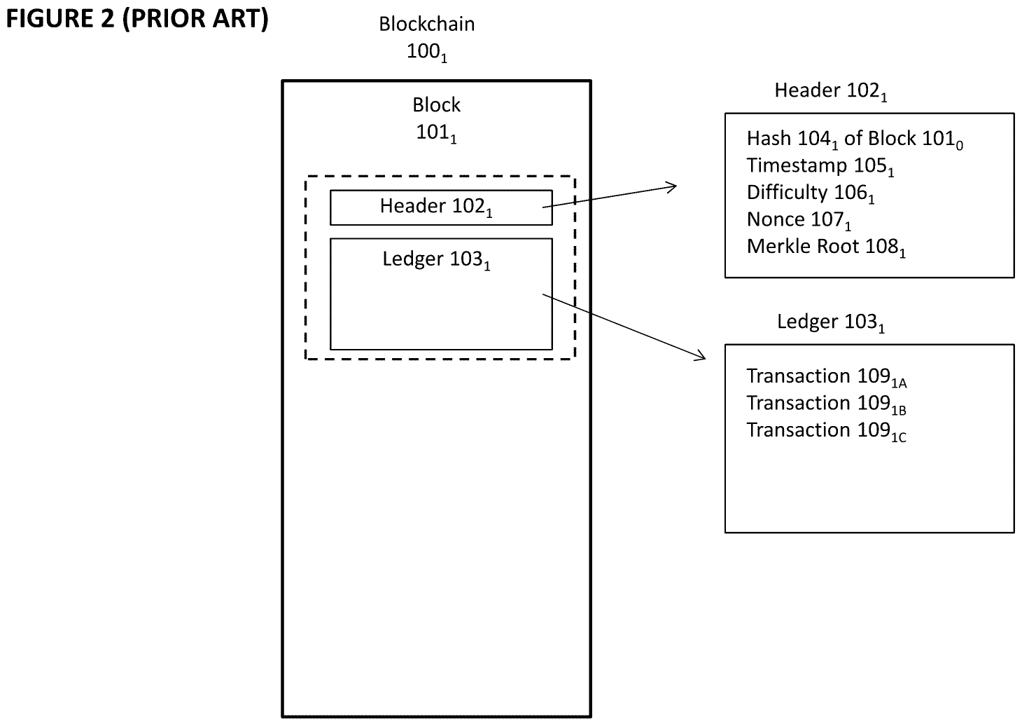

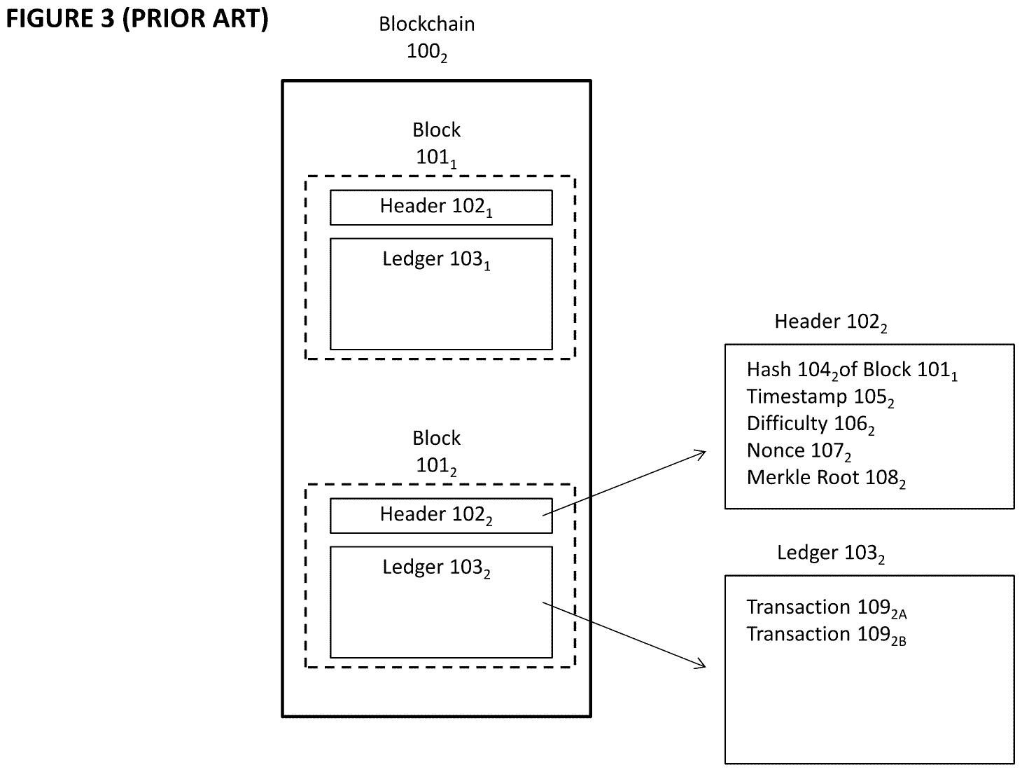

### DETAILED DESCRIPTION OF THE INVENTION

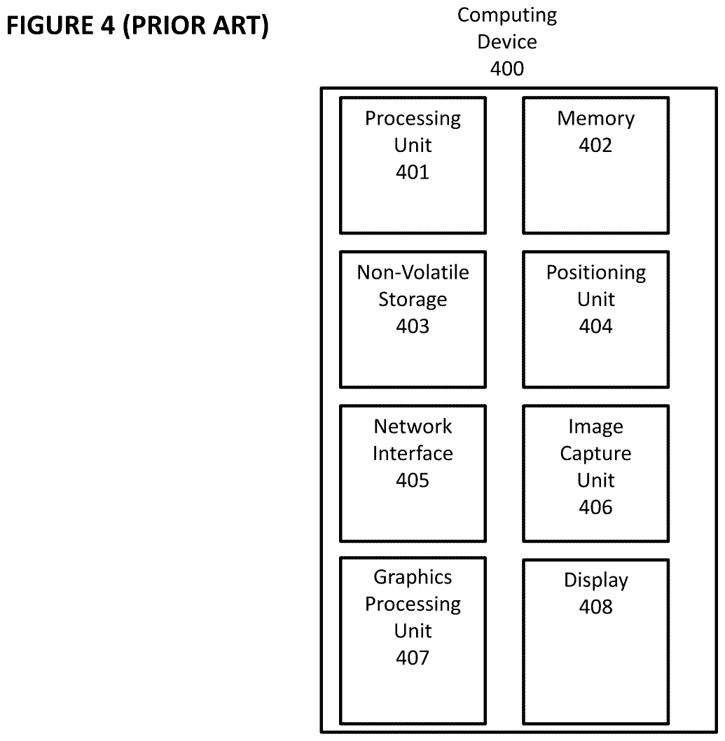

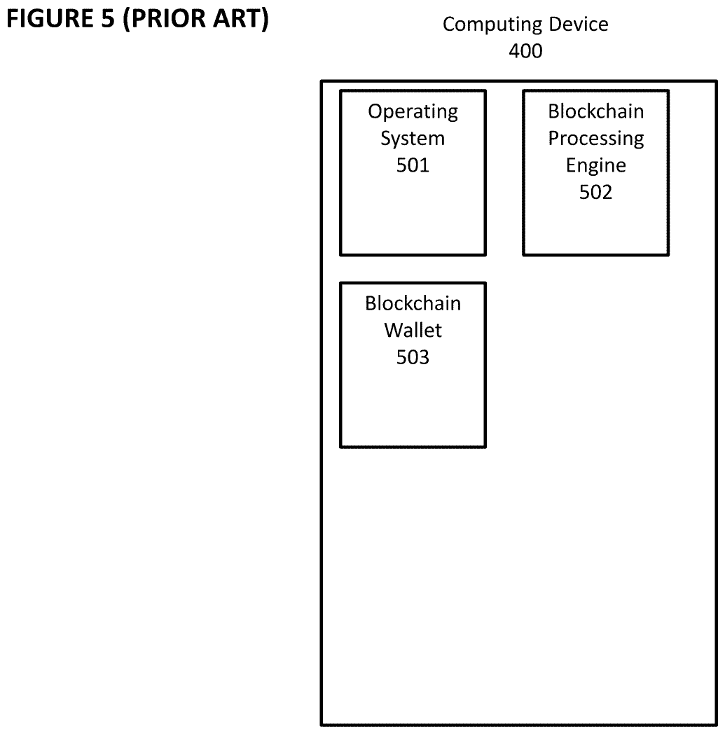

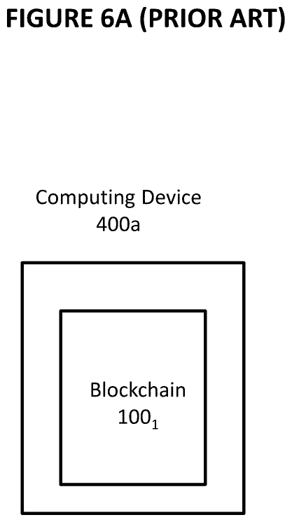

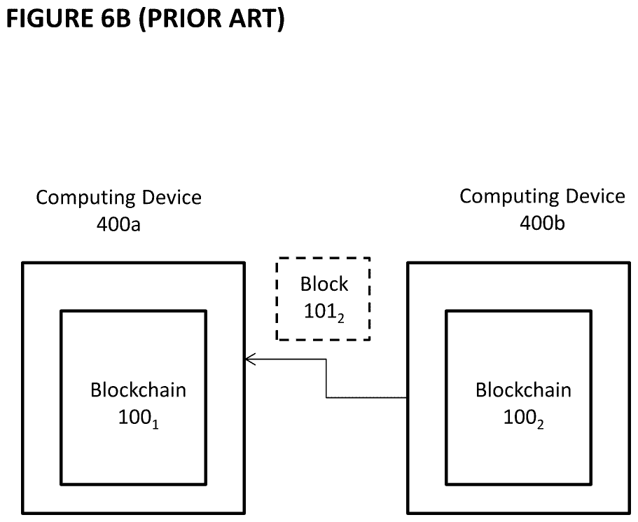

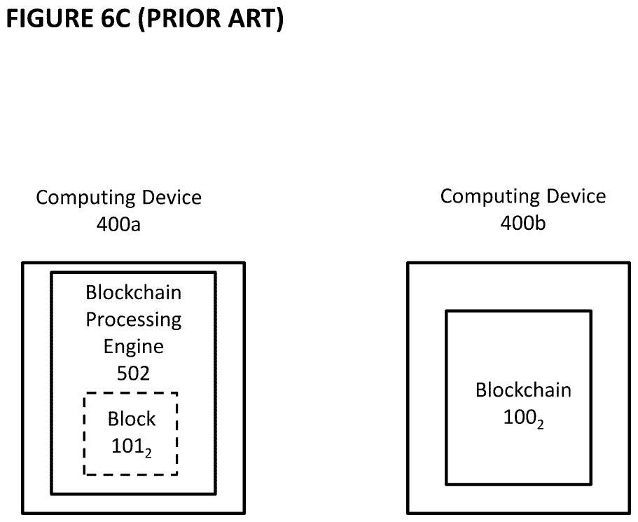

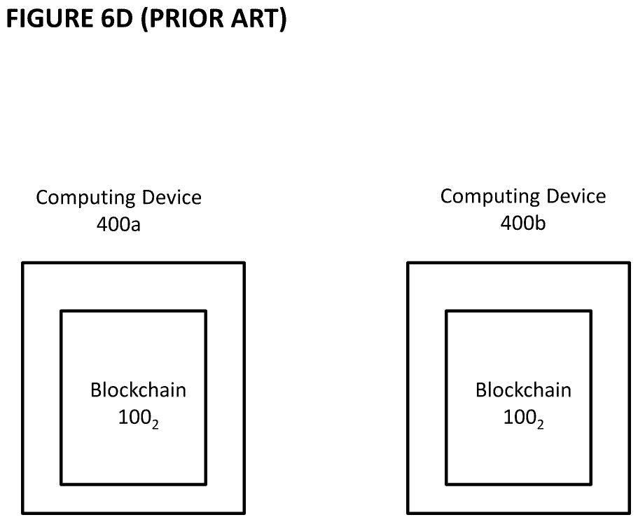

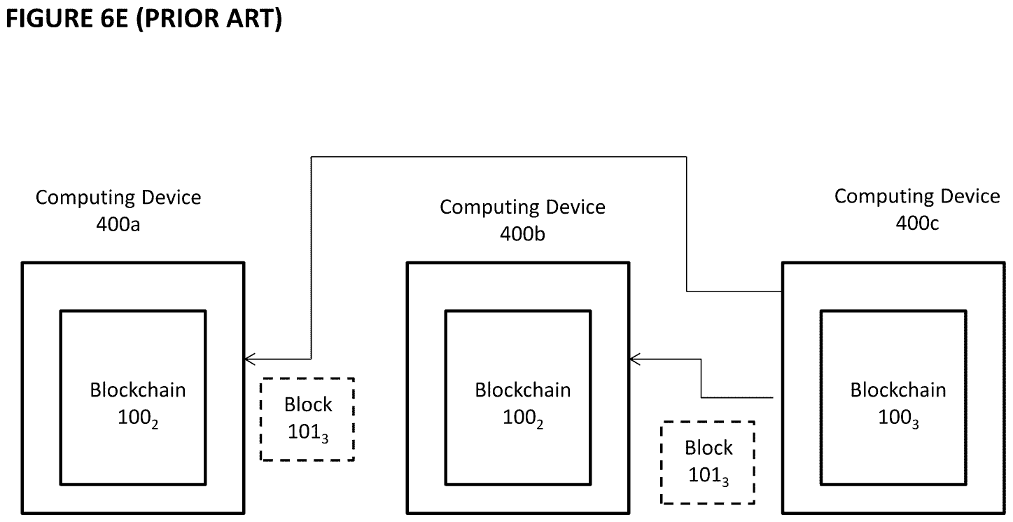

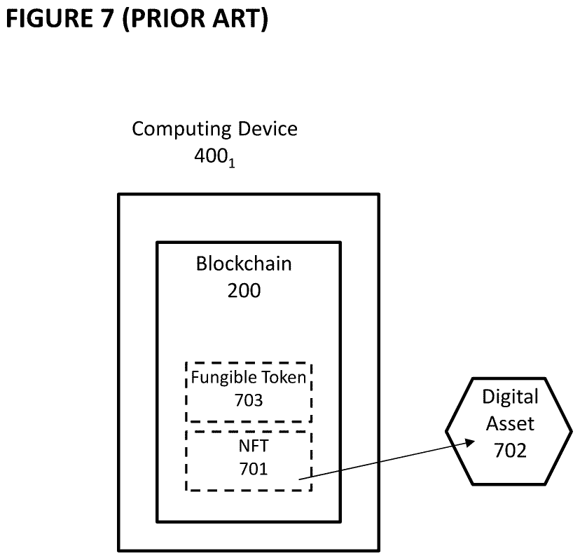

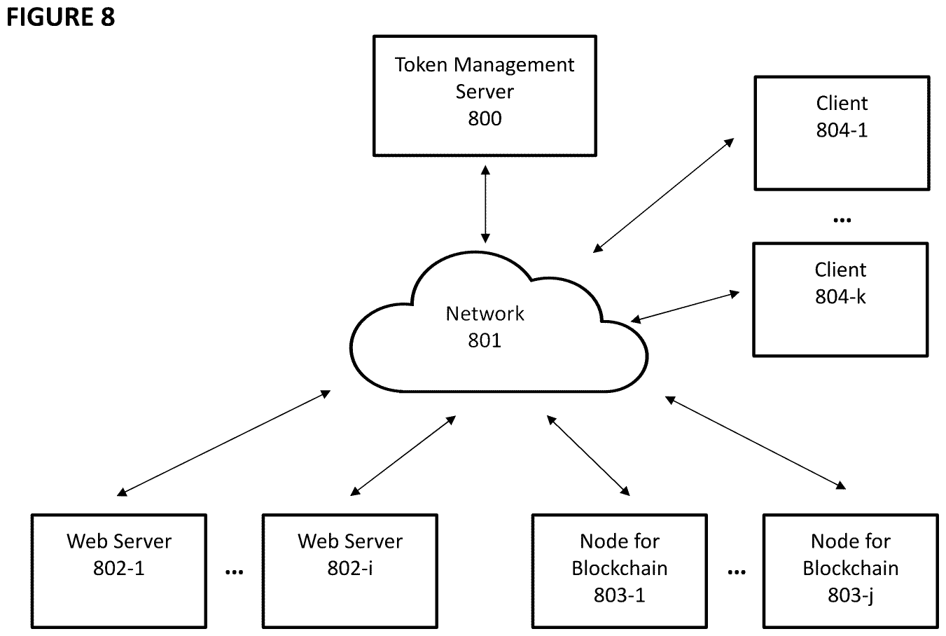

FIG. 8 depicts token management server 800. Token management server 800 is a computing device such as computing device 400 described previously with reference to FIGS. 4 and 5.

Token management server 800 communicates via network 801 with web servers 802-1, . . . , 802-i, nodes for blockchains 803-1, . . . , 803-j, and clients 804-1, . . . , 804-k, where i, j, and k are integers. Web servers 802, nodes for blockchains 803, and clients 804 each are a computing device such as computing device 400 described previously with reference to FIGS. 4 and 5

As discussed in greater detail below, web servers 802 include all web servers hosting websites of interest, and nodes for blockchains 803 represent all blockchains of interest. Although FIG. 8 depicts token management server 800 as a single computing device, it will be appreciated that token management server 800 optionally may comprise multiple computing devices, such as multiple servers in the cloud.

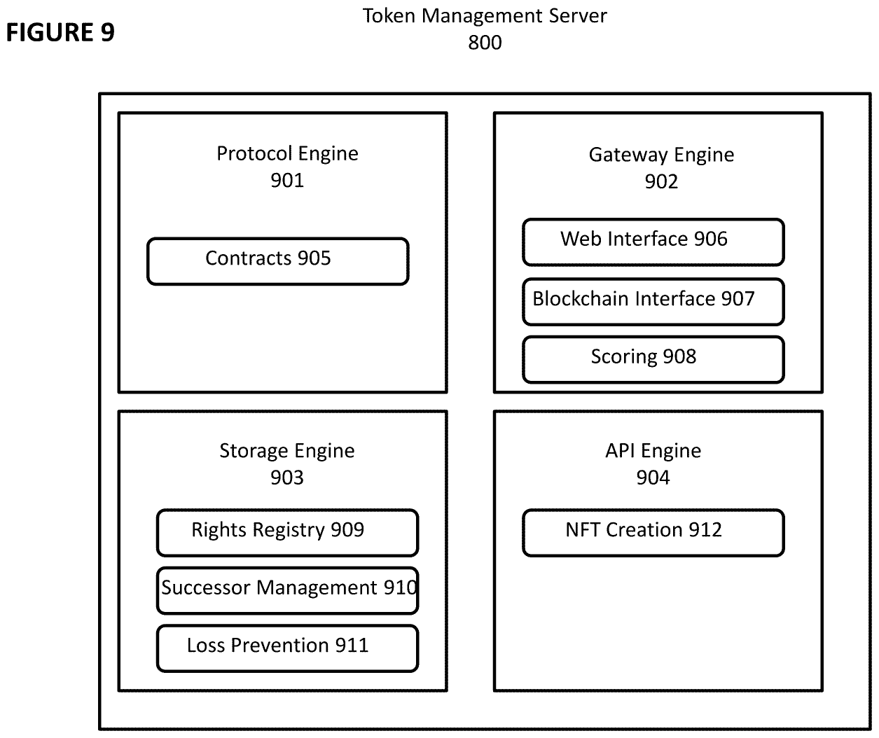

FIG. 9 depicts additional software components of token management server 800 that perform the functionality described herein. Token management server 800 comprises protocol engine 901, gateway engine 902, storage engine 903, and API engine 904. Protocol engine 901, gateway engine 902, storage engine 903, and API engine 904 and each comprises lines of software code that can be executed by processing unit 401 in token management server 800.

Additional detail will now be provided regarding the various software components of token management server 800.

Protocol Engine 901

Protocol engine 901 comprises contracts engine 905. Contracts engine 905 implements a smart contract protocol for the issuance, rights management, and protection of NFTs and their associated digital assets as well as and fungible digital assets. Optionally, contracts engine 905 automatically generates documentation of the ownership and associated intellectual property rights (e.g., copyrights) for the digital asset associated with the NFT and tracks any changes of ownership or assignment of the digital asset or the underlying intellectual property rights. Protocol engine 901 also can instruct gateway engine 902, described below, to scan web servers and blockchains for instances of substantial copying of the digital asset, which in some instances may constitute copyright infringement.

Gateway Engine 902

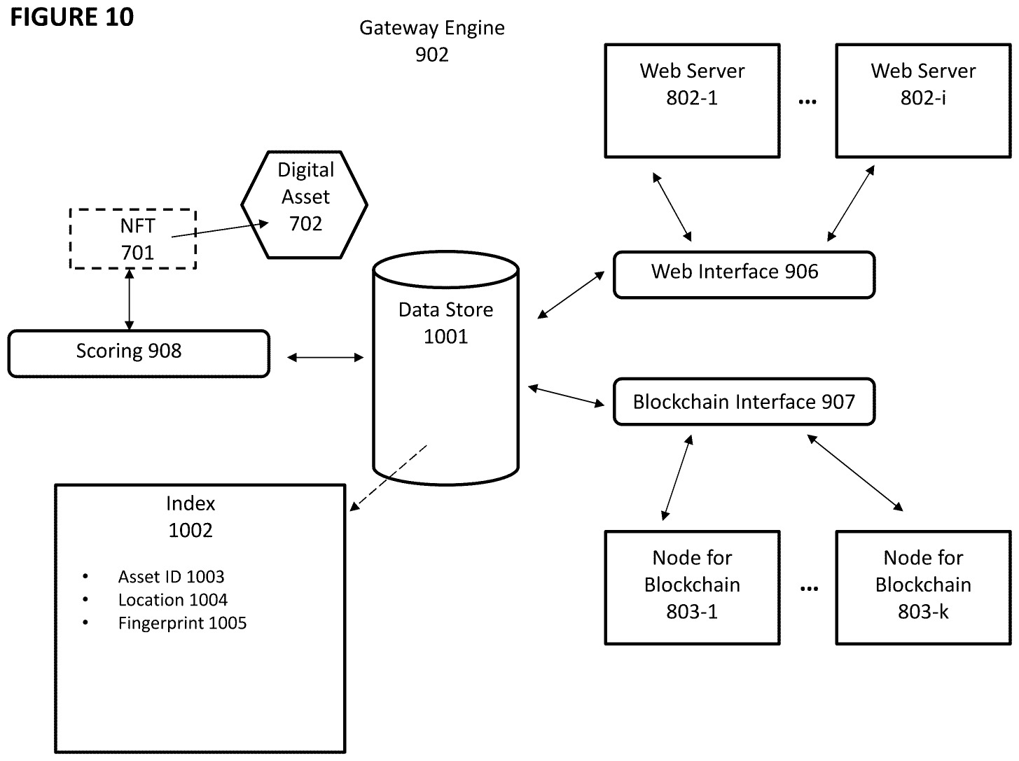

Gateway engine 902 comprises web interface 906, blockchain interface 907, and scoring engine 908. With reference to FIG. 10, web interface 906 scours web servers 802-1, . . . , 802-i and blockchain interface 907 scours nodes for blockchains 803-1, . . . , 803-j to identify and index digital items of interest, such as: images, videos, audio, video game items, digital collectibles, and other types of digital files.

Once a digital item of interest is found, and index entry is added to index 1002 in data store 100₁. Index 1002 stores attributes for each digital item of interest items identified by web interface 906 and blockchain interface 907, such as asset ID 1003, location 1004 of the asset, and a fingerprint 1005 for the asset.

Fingerprint 1005 is a digital value that is calculated from the digital item of interest. For example, fingerprint 1005 can be a hash of all or some of the digital data within the digital item of interest.

Scoring engine 908 can compare an NFT and its digital asset, such as NFT 701 and digital asset 702, or a fingerprint 1005 thereof, against index 1002 to identify items that are identical to NFT 701 or digital asset 702 or similar to NFT 701 or digital asset 702 within a certain threshold. For example, scoring engine 908, can generate a fingerprint 1005 for NFT 701 and digital asset 702 and compare that fingerprint 1005 to the fingerprints 1005 stored in index 1002. In this manner, gateway engine 902 analyzes provenance, uniqueness, and rights associated with NFTs and their associated digital assets. This analysis can identify instances of copyright infringement.

Storage Engine 903

Storage engine 903 comprises rights registry engine 909, successor management engine 910, and loss prevention engine 911.

Rights registry engine 909 is a repository of digital assets rights tied with physical and digital identities.

Successor management engine 910 provides a mechanism for transferring ownership and control of an NFT and its associated digital asset, or a fungible token, in the event that the current owner of the NFT or the fungible token dies, becomes incapacitated, or disappears from the NFT platform or fungible token platform.

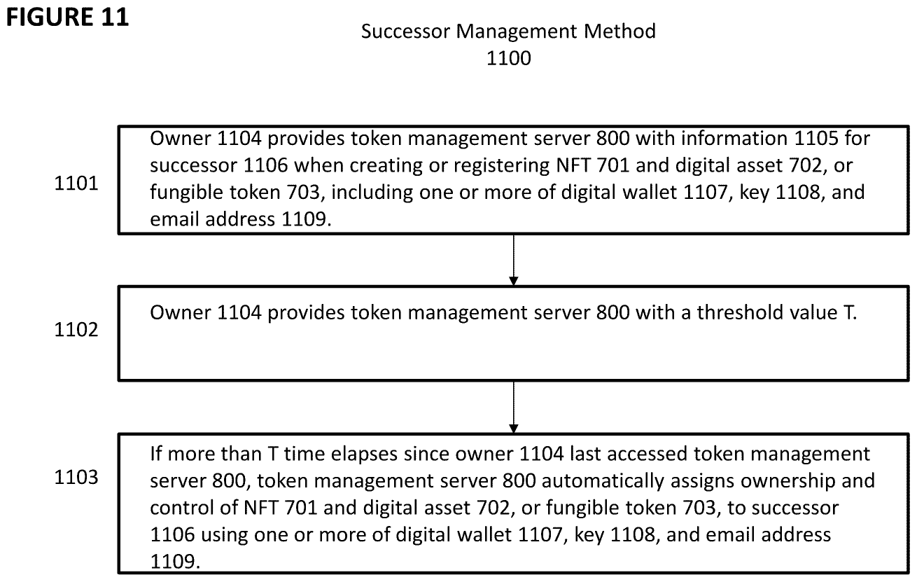

FIG. 11 depicts successor management method 1100 implemented by successor management engine 910. Owner 1104 provides token management server 800 with information 1105 for successor 1106 when creating or registering NFT 701 and digital asset 702, or fungible token 703, including one or more of digital wallet 1107, key 1108, and email address 1109 (step 1101). Owner 1104 provides token management server 800 with a threshold value T (step 1102). An example of T might be 30 days or 6 months. If more than T time elapses since owner 1104 last accessed token management server 800, token management server 800 automatically assigns ownership and control of NFT 701 and digital asset 702, or fungible token 703, to successor 1106 using one or more of digital wallet 1107, key 1108, and email address 1109 (step 1103).

With reference again to FIG. 9, loss prevention engine 911 implements a mechanism for maintaining an NFT and associated digital asset, or a fungible token, if the owner of the NFT and digital asset, or the fungible token, loses the mechanism for accessing the NFT and digital asset, or the fungible token, such as losing a digital wallet.

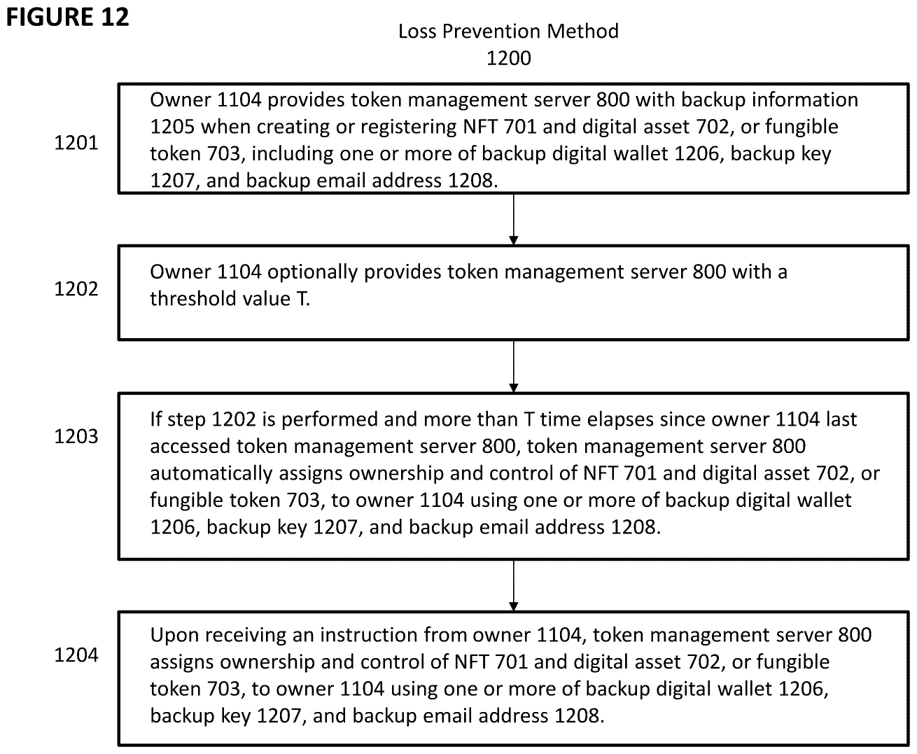

FIG. 12 depicts loss prevention method 1200 performed by loss prevention engine 911. Owner 1104 provides token management server 800 with backup information 1205 when creating or registering NFT 701 and digital asset 702, or fungible token 703, including one or more of backup digital wallet 1206, backup key 1207, and backup email address 1208 (step 1201). Owner 1104 optionally provides token management server 800 with a threshold value T (step 1202). If step 1202 is performed and more than T time elapses since owner 1104 last accessed token management server 800, token management server 800 automatically assigns ownership and control of NFT 701 and digital asset 702, or fungible token 703, to owner 1104 using one or more of backup digital wallet 1206, backup key 1207, and backup email address 1208 (step 1203). Upon receiving an instruction from owner 1104, token management server 800 assigns ownership and control of NFT 701 and digital asset 702, or fungible token 703, to owner 1104 using one or more of backup digital wallet 1206, backup key 1207, and backup email address 1208 (step 1204).

API Engine 903

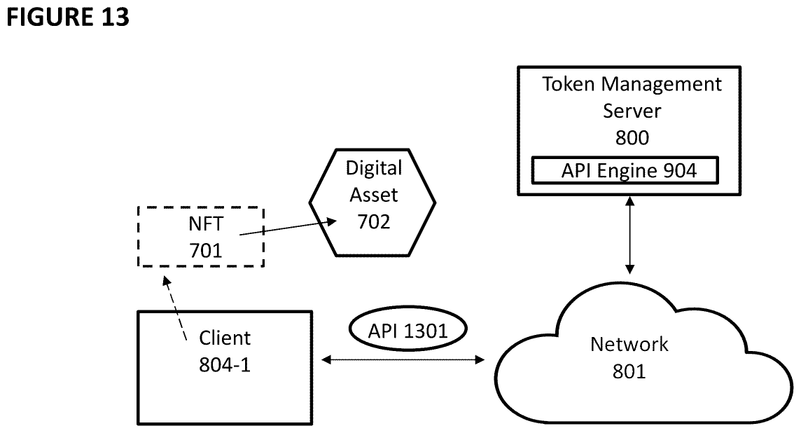

With reference again to FIG. 9, API engine 904 comprises NFT creation engine 912. NFT creation engine 912 enables users to create multi-chain NFTs along with their associated rights, generate and update records in the registry, accessing NFT uniqueness scores generated by scoring engine 908, and performing anti-infringement checks on NFTs. With reference to FIG. 13, API engine 904 enables external devices such as client 804-1 to interact with token management server 800 through API 1301 that is serviced by API engine 904.

For example, API 1301 might comprise a command by which client 804-1 asks token management server 800 (using gateway engine 902, not shown) to perform a search within web servers 802 (not shown) and nodes for blockchains 803 (not shown) to identify digital items that are identical to NFT 701 and digital asset 702 or similar to NFT 701 and digital asset 702 within a certain predetermined threshold.

It is to be understood that the present invention is not limited to the embodiment(s) described above and illustrated herein but encompasses any and all variations evident from the above description. For example, references to the present invention herein are not intended to limit the scope of any claim or claim term, but instead merely make reference to one or more features that may be eventually covered by one or more claims.

What is claimed is:

1. A method comprising:
identifying a first set of digital items on one or more web servers;
generating a fingerprint for each digital item in the first set of digital items;
identifying a second set of digital items on one or more blockchains;
generating a fingerprint for each digital item in the second set of digital items;
generating a fingerprint for a selected NFT and digital asset; and
comparing the fingerprint for the selected NFT and digital asset to fingerprints for the first set of digital items and fingerprints for the second set of digital items.

2. The method of claim 1, further comprising:
storing one or more entries for the first set of digital items in an index.

3. The method of claim 2, further comprising:
storing one or more entries for the second set of digital items in the index.

4. The method of claim 3, wherein the one or more entries for the second set of digital items comprise fingerprints for the second set of digital items.

5. The method of claim 2, wherein the one or more entries for the first set of digital items comprise fingerprints for the first set of digital items.

6. The method of claim 1, further comprising:
indicating, based on the comparing step, that the digital asset is identical to one or more of the digital items in the first set of digital items and the second set of digital items.

7. The method of claim 6, further comprising:
storing in a registry the digital asset.

8. The method of claim 1, further comprising:
indicating, based on the comparing step and a predetermined threshold, that the digital asset is similar to one or more of the digital items in the first set of digital items and the second set of digital items.

9. The method of claim 1, further comprising:
storing in a registry the digital asset.

10. A method comprising:
providing a token management server with information for a successor, the information comprising one or more of a digital wallet, a key, and an email address;
providing token management server with a threshold value; and
when time since owner last accessed token management server exceeds the threshold value, token management server automatically assigns ownership and control of a digital item to the successor using one or more of the digital wallet, key, and email address.

11. The method of claim 10, wherein the digital item comprises an NFT and associated digital asset.

12. The method of claim 10, wherein the digital item comprises a fungible token.

13. A method comprising:
providing a token management server with backup information for an owner when creating or registering a digital item, backup information comprising one or more of a backup digital wallet, a backup key, and a backup email address; and
in response to an instruction, assigning ownership and control of the digital item to the owner using one or more of backup digital wallet, backup key, and backup email address.

14. The method of claim 13, wherein the digital item comprises an NFT and associated digital asset.

15. The method of claim 13, wherein the digital item comprises a fungible token.

16. The method of claim 13, further comprising:
establishing, by token manager server, a threshold value; and
when time since an owner last accessed token management server exceeds the threshold value, token management server automatically assigns ownership and control of the digital item to a successor using one or more of a digital wallet, a key, and an email address.

17. A token management server comprising:
a gateway engine for generating and storing entries in an index for a first set of digital items on one or more web servers and a second set of digital items on one or more blockchains and comparing one or more of the entries to an NFT and digital asset.

18. The token management server of claim 17, further comprising:
a successor management engine for assigning ownership and control of the NFT and digital asset from an owner to a successor using one or more of a digital wallet, a key, and email address when a time since the owner last accessed the token management server exceeds a threshold value.

19. The token management server of claim 18, further comprising:
a loss prevention engine for assigning ownership and control of the NFT and digital asset to the owner using one or more of a backup digital wallet, a backup key, and a backup email address.

20. The token management server of claim 17, further comprising:
a loss prevention engine for assigning ownership and control of the NFT and digital asset to an owner using one or more of a backup digital wallet, a backup key, and a backup email address.

21. A method comprising:
generating a digital asset and associated NFT;
storing the NFT in a blockchain;
generating an ownership document for the digital asset;
storing ownership information for the digital asset in the blockchain; and
storing updated ownership information for the digital asset in the blockchain when ownership of the digital asset changes.

22. The method of claim 21, further comprising:
generating a fingerprint for the NFT and digital asset; and
comparing the fingerprint to fingerprints store for digital items.

23. The method of claim 22, further comprising:
indicating, based on the comparing step, that the digital asset is identical to one or more of the digital items.

24. The method of claim 22, further comprising:
indicating, based on the comparing step and a predetermined threshold, that the digital asset is similar to one or more of the digital items.
